(19) United States
(12) Patent Application Publication
(10) Pub. No.: US 2012/0145811 A1
(43) Pub. Date: Jun. 14, 2012

(54) Spray Head Press Structure for Use of Kitchen Counters

(76) Inventor: Ho-Fa Yang, Lu Kang Chen (TW)

(21) Appl. No.: 12/967,516

(22) Filed: Dec. 14, 2010

(51) Int. Cl. B05B 9/01

(52) U.S. Cl. 239/526

(57) ABSTRACT

A spray head press structure for use of kitchen counters comprises a control valve mounted into an extensive conduit of a body and regulated via a press handle attached at the rear side of the body, and a locking collar secured to a threaded hole at the bottom of the body. The control valve includes a cross-shaped guidance end extending beneath a restrictive flange to mount to a spring element and flexibly conjoin to the locking collar. The locking collar has multiple water-intake orifices annularly arranged at the top surface and a central tubular positioning section for the transport of water into the body and the positioning of the guidance end respectively. Thus, the control valve can be linearly restricted in movement via the positioning section, and the upwards flush of the water and the descending control valve can be separated from each other, achieving smooth and effortless operation thereby.

### BACKGROUND OF THE INVENTION

The present invention relates to a spray head press structure for use of kitchen counters wherein a control valve is mounted to an extensive conduit of a body and regulated via a press handle attached at the rear side of the body, and a locking collar having annularly-arranged water-intake orifices and a central tubular positioning section protruding thereon is secured to a threaded hole at the bottom of the body; whereby, the control valve can be linearly restricted in movement via the positioning section of the locking collar, and the upwards flush of water flow and the descending control valve can be separated without interfering with each other, achieving smooth and effortless operation thereby.

Please refer to FIG. 4 showing an exploded perspective view of a conventional kitchen spray head structure (accompanied by FIG. 5). The conventional kitchen spray head 70 includes a body 71 and a control valve 72 equipped with a top shaft 721 to be mounted to the interior of the body 71 thereby. The body 71 has an extensive conduit 711 drilled through the top end of the body 71 for the accommodation of the control valve 72 therein. The body 71 has the rear side defined by a depressed handle chamber 713 with an insert plate 712 extending thereon to which a press handle 73 with an insert cavity 731 disposed thereon is joined and mounted thereto. Thus, the top shaft 721 is allowed to precisely abut against the internal surface of the press handle 73 thereby. The body 71 has the bottom equipped with a two-step threaded hole 714 to which a locking collar 74 having a central water-intake vent 741 defining therein is fixedly secured thereby. The top shaft 721 thereof has a water-sealing hoop 722 mounted to the appropriate position thereon so as to seal tight against the internal surface of the extensive conduit 711 thereby. The control valve 72 has the top edge equipped with a larger-diameter stop ring 724 with a protrusive rod 7241 extending thereon to which a watertight pack 723 and the top shaft 721 are sequentially mounted and coupled therewith. The control valve 72 has the lower section equipped with a protrusive stop flange 725 to which a spring element 75 is conjoined to flexibly abut against the locking collar 74 thereby. Thus, the top shaft 721 and the stop ring 724 of the control valve 72 flexibly bounced by the spring element 75 are simultaneously pushed to abut against the internal surface of the press handle 73 and the lower end surface of the extensive conduit 711 so as to close up the water discharge thereby. Then, the press handle 73 pushed by the top shaft 721 will have the lower section bending slightly outwards to keep an appropriate distance from the handle chamber 713 for gripping and pressing purposes (as shown in FIG. 5). In operation, the control valve 72 is pressed downwards to compress the spring element 75 till the watertight packing 723 detaching from the extensive conduit 711 so as to switch open the water discharge thereby. Then, the water flow entering the extensive conduit 711 and blocked by the water-sealing hoop 722 is allowed to flush onwards to a spray portion 715 extending at the front of the body 71 and transported outwards there-from. A spray spout 76 equipped with a decorative cover 761 can be mounted to the interior of the spray portion 715 thereof, permitting the water flow to be emitted outwards in a pattern of radial spray thereby.

However, there are some drawbacks to such conventional kitchen spray head structure. First, the control valve 72 is flexibly pushed and supported via the spring element 75 to suspend above the locking collar 74 thereof. When the press handle 73 is pushed to press downwards the control valve 72, the descending control valve 72 without any guiding and positioning support will counteract with the upwards bouncing force of the spring element 75 and go awry in movement (referring to FIG. 6). As a result, the spring element 75 with uneven force exerting thereon can easily become twisted and deformed, affecting the water-discharge space defined by the watertight packing 723 and the extensive conduit 711 thereof. Besides, the watertight packing 723 and the stop ring 724 of the control valve 72 can also get displaced to contact the interior of the body 71 and become loosened, which is quite inconvenient in application. Second, the control valve 72 has the bottom side defined by a right-angle flat surface, which can easily jar with the conjoining end surface of the spring element 75 and result in awkward assembly. Third, the water flow is collectively gathered via the water-intake vent 741 of the locking collar 74 to enter the interior of the body 71. Thus, the water flow will directly flush against the bottom surface and the stop flange 725 of the control valve 72, instantly forming a counterforce reacting against the descending control valve 72, which can result in difficult operation thereby.

### SUMMARY OF THE PRESENT INVENTION

It is, therefore, the primary purpose of the present invention to provide a spray head press structure for use of kitchen counters wherein a locking collar has the top side equipped with a protrusive positioning section to which a guidance end extending at the lower section of a control valve is conjoined therewith to provide guiding and positioning effects thereby, permitting the control valve to be linearly restricted in movement via the positioning section thereof so as to prevent the control valve from going awry and a spring element from getting deformed as found in the above-mentioned conventional spray head structure; whereby, force can be evenly applied onto the control valve and the spring element to ensure the best water-outlet space and water discharge thereby.

It is, therefore, the second purpose of the present invention to provide a spray head press structure for use of kitchen counters wherein the guidance end of the control valve has a bottom defined by an arcuate guiding surface to match to the spring element and the positioning section of the locking collar respectively, permitting easy and smooth assembly thereby.

It is, therefore, the third purpose of the present invention to provide a spray head press structure for use of kitchen counters wherein the locking collar has multiple water-intake orifices annularly arranged at the top surface thereon for the transport of water flow into a body thereof, and the positioning section of the locking collar is provided protruding in the center to conjoin to the guidance end of the control valve; whereby, the upwards flush of the water flow and the descending control valve are separately divided from each other so that the actuation of the control valve can be free from the interference of the water flow, achieving effortless operation thereby.

### BRIEF DESCRIPTION OF THE DRAWINGS

FIG. 1 is an exploded perspective view of the present invention.

FIG. 2 is an assembled cross sectional view of the present invention.

FIG. 3 is a diagram showing the present invention in pressing operation thereof.

FIG. 4 is an exploded perspective view of a conventional spray head structure.

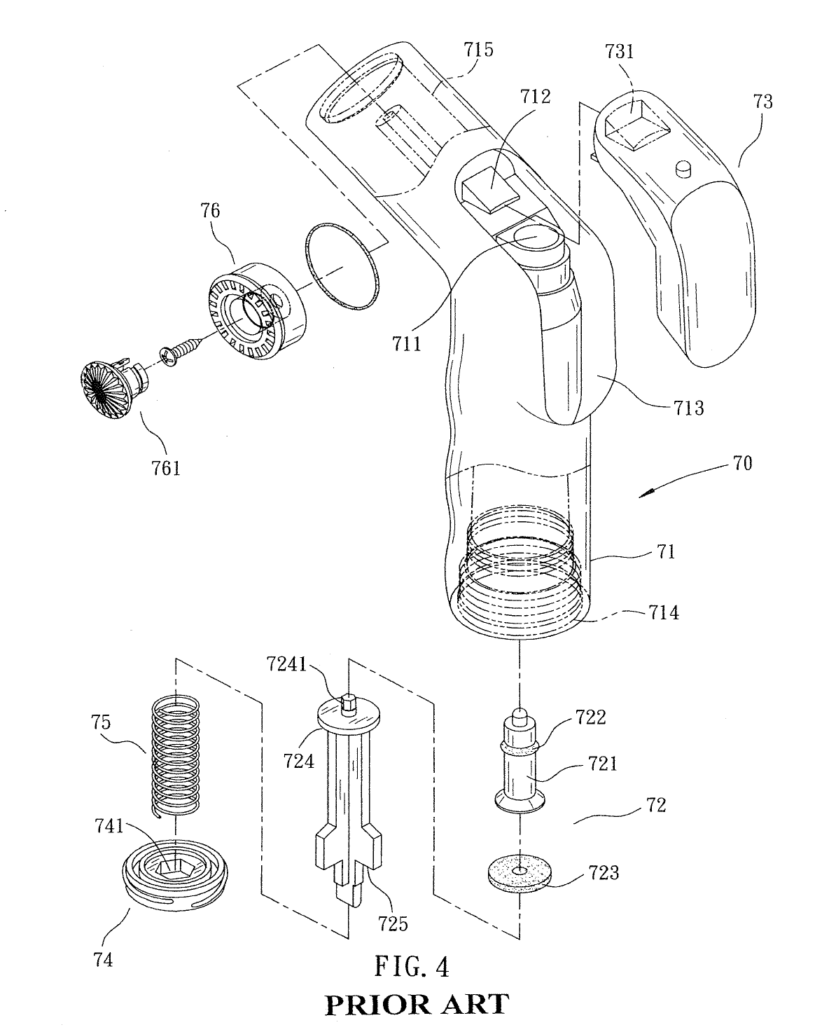

FIG. 5 is an assembled cross sectional view of the conventional spray head structure.

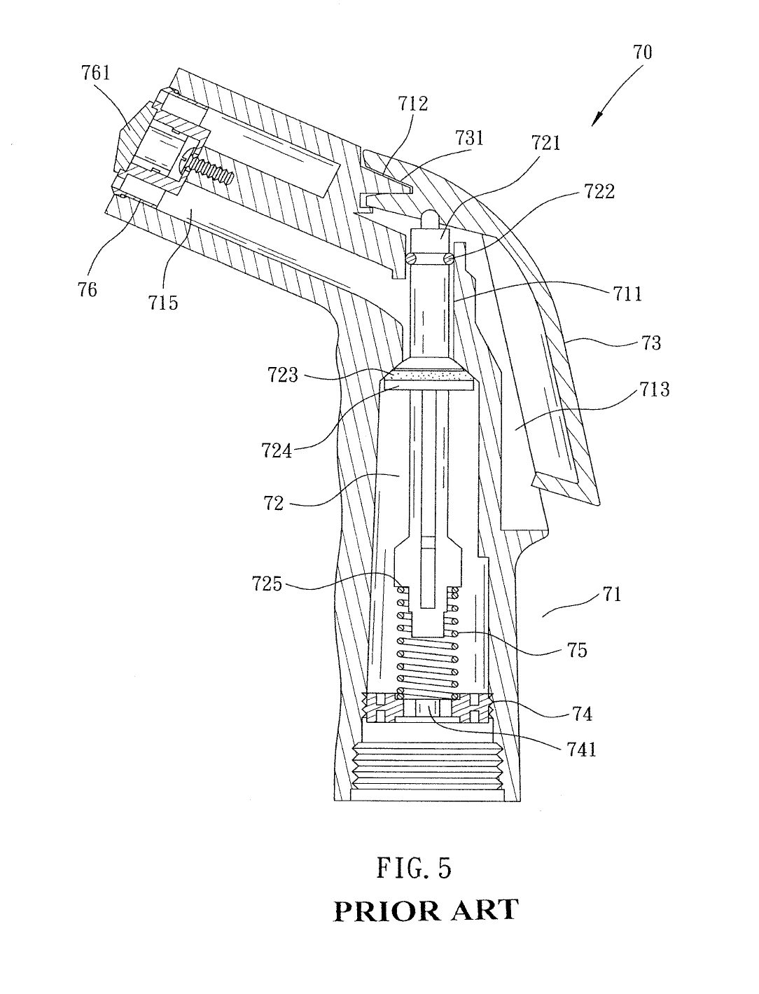

FIG. 6 is a diagram showing the conventional spray head in pressing operation thereof.

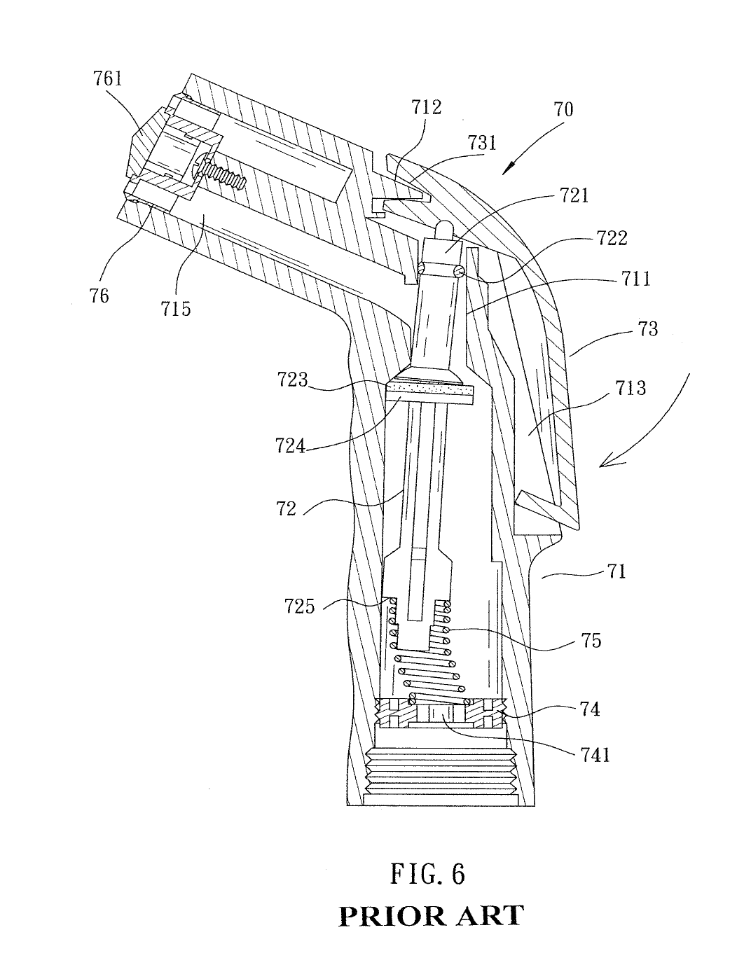

### DETAILED DESCRIPTION OF THE PREFERRED EMBODIMENTS

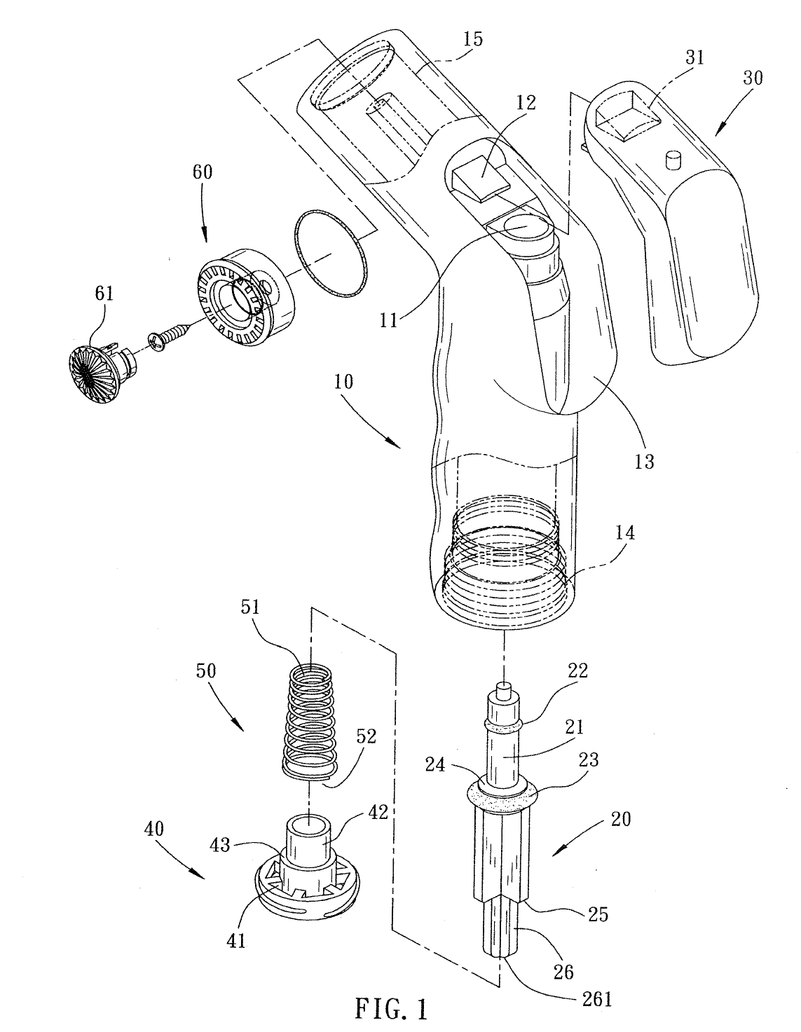

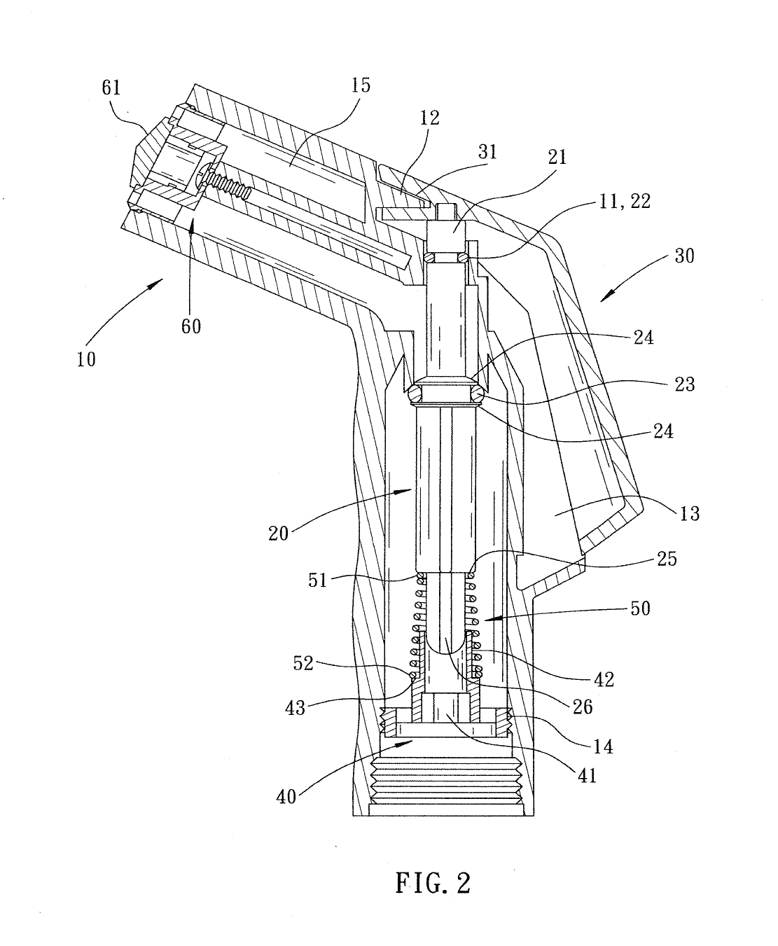

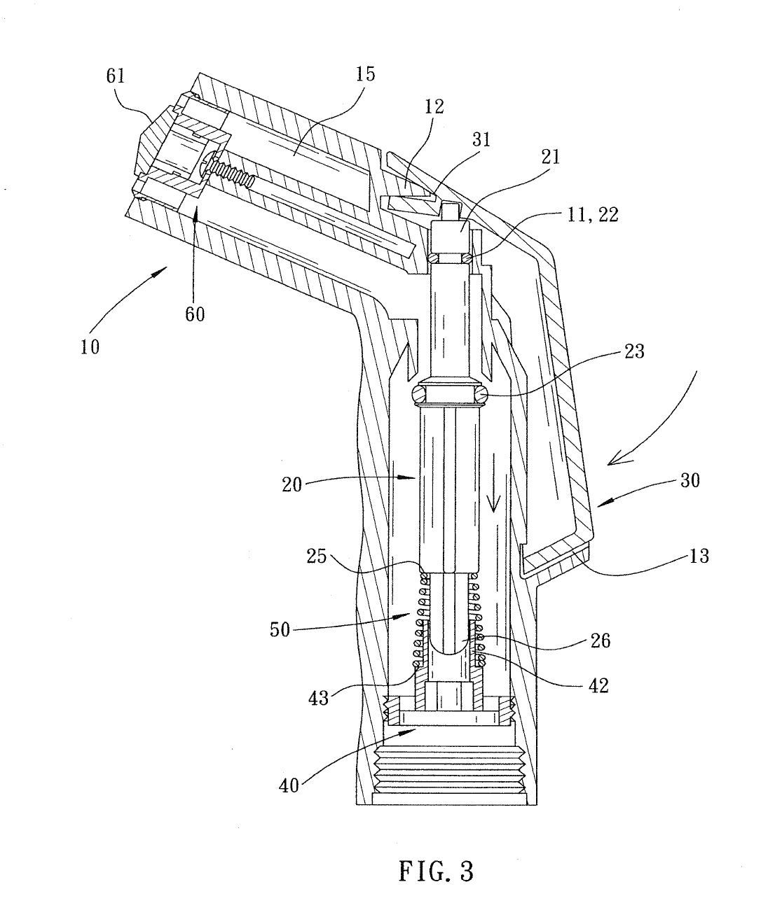

Please refer to FIG. 1 showing an exploded perspective view of the present invention (accompanied by FIG. 2). The present invention relates to a spray head press structure for use of kitchen counters, comprising a body 10 to the interior of which is mounted a control valve 20 wherein the control valve 20 has the upper section equipped with an integrally-extending top shaft 21 with a sealing ring 22 mounted thereto to be guided through an extensive conduit 11 disposed at the top end of the body 10 thereof The body 10 has the rear side defined by a depressed handle chamber 13 with an insert plate 12 extending thereon to fit to an insert groove 31 of a press handle 30 thereby. Thus, the top shaft 21 is allowed to precisely abut against the inner surface of the press handle 30 thereof The body 10 has the bottom end equipped with a two-step threaded hole 14 to which a locking collar 40 is firmly secured thereto. The control valve 20 has the middle section equipped with a larger-diameter stop flange 24 to which a watertight ring 23 is mounted and located thereto. The body 10 also has a cross-shaped lower section extending downwards to form a restrictive flange 25 and a smaller-diameter guidance end 26 extending at the bottom of the restrictive flange 25 thereof A spring element 50 is mounted to the guidance end 26 and flexibly abutted against the locking collar 40 thereby. The guidance end 26 thereof has the bottom defined by an arcuate guiding surface 261, facilitating easy and smooth assembly of the spring element 50 onto the control valve 20. The locking collar 40 has multiple water-intake orifices 41 annularly arranged at the top surface thereon for the transport of water flow into the body 10 thereby, and a tubular positioning section 42 protruding at the center for the engagement of the guidance end 26 therewith. Then, the upwards flush of the water flow and the downwards movement of the control valve 20 can be separated without counteracting with each other, permitting the control valve 20 to actuate smoothly without being interfered by the water flow and achieving effortless operation thereby. In addition, the positioning section 42 thereof has the outer periphery equipped with a stepwise stop seat 43, permitting the spring element 50 to have both ends respectively abutting against the restrictive flange 25 and the stop seat 43 thereby. The spring element 50 is matched to the outer diameters of the guidance end 26 and the positioning section respectively and molded into an upper-narrow-and-lower-wide tapered configuration, forming a first coupling end 51 and a second coupling end 52 respectively so as to reinforce and strengthen the position of the spring element 50 thereby. Thus, the sealing ring 22 and the watertight ring 23 of the control valve 20 can be accurately pushed by the flexibility of the spring element 50 to seal tight against the internal surface and the lower end surface of the extensive conduit 11 respectively to close the water discharge in a shutoff state. Meanwhile, the press handle 30 is precisely pushed by the top shaft 21 to bend slightly outwards so as to keep an appropriate distance from the depressed handle chamber 13 for gripping and pressing purposes thereof (referring to FIG. 3). In application, the top shaft 21 of the control valve 20 is squeezed by the press handle 30 to descend downwards along the extensive conduit 11, compressing the spring element 50 till the watertight ring 23 detaches from the extensive conduit 11 to open the water discharge and permit water flow to flush into the extensive conduit 11 thereby. Then, blocked by the sealing ring 22, the water flow inside the extensive conduit 11 will be transported to come out through a spray portion 15 extending at the front of the body 10 thereof. The spray portion 15 has the interior equipped with a spray head 60 with a decorative cover 61 mounted thereto, permitting the water flow to be emitted outwards there-through in a pattern of radial-shaped spray thereby. Furthermore, the positioning section 42 of the locking collar 40 is utilized and coupled with the guidance end 26 of the control valve 20 to provide guiding and positioning effects thereby. Thus, the control valve 20 can be ensured to actuate precisely a linear movement, and pressing force can be evenly exerted onto the control valve 20 and the spring element 50, maintaining the best water-discharge space and the application state thereby.

What is claimed is:

1. A spray head press structure for use of kitchen counters, comprising a body having a top side defined by an extensive conduit to which a control valve equipped with a top shaft is mounted thereto, and a press handle is mounted to the rear side of the body so as to regulate the movement of the control valve thereby; the internal bottom edge of the body is disposed a threaded hole to which a locking collar is fixedly secured thereto; besides, a spring element is mounted between the control valve and the locking collar thereof; the present invention being characterized by that,
the control valve having a restrictive flange extending at the lower section thereon, and a guidance end extending downwards beneath the restrictive flange to couple with the spring element and flexibly mount to the locking collar thereby;
the locking collar having multiple water-intake orifices annularly arranged at the top surface thereon, a tubular positioning section protruding at the center to which the guidance end of the control valve is mounted thereto, and a stepwise stop seat extending at the outer periphery of the positioning section thereon, permitting both ends of the spring element to precisely abut against the restrictive flange and the stop seat respectively;
whereby, the positioning section of the locking collar is utilized and coupled with the guidance end of the control valve to provide guiding and positioning effects so that the control valve, restricted in actuation by the positioning section thereof, can operate straight in a linear movement thereby; besides, the water-intake orifices and the positioning section of the locking collar are respectively applied for the transport of water flow into the body and the positioning of the guidance end of the control valve thereof; therefore, the upwards flush of the water flow can be separated from the downwards impact of the descending control valve, and the actuation of the control valve can be free from the interference of the water flow, achieving smooth and effortless operation thereby.

2. The spray head press structure for use of kitchen counters as claimed in claim 1 wherein the spring element is matched to the outer diameters of the guidance end of the control valve and the positioning section of the locking collar respectively, and molded into an upper-narrow-and-lower-wide tapered configuration, forming a first coupling end and a second coupling end at both sides so as to reinforce and strengthen the position of the spring element thereby.

3. The spray head press structure for use of kitchen counters as claimed in claim 1 wherein the top shaft thereof can be integrally molded to the upper section of the control valve and equipped with a sealing ring thereon, permitting the top shaft to precisely abut against the internal surface of the press handle; the control valve also has the middle section equipped with a larger diameter stop flange to which a watertight ring is mounted and located thereto.

4. The spray head press structure for use of kitchen counters as claimed in claim 1 wherein the restrictive flange and the guidance end of the control valve are respectively molded in a cross-shaped configuration thereof.

5. The spray head press structure for use of kitchen counters as claimed in claim 1 wherein the bottom of the guidance end thereof is molded into an arcuate guiding surface thereof.
